(19) United States
(12) Patent Application Publication
(10) Pub. No.: US 2011/0291928 A1
(43) Pub. Date: Dec. 1, 2011

(54) Multifunctional flexible handwriting board and method for manufacturing the same

(76) Inventor: Po-Ju Chou, Xindian City (TW)

(21) Appl. No.: 12/790,900

(22) Filed: May 31, 2010

(51) Int. Cl. G06F 3/033

(52) U.S. Cl. 345/158

(57) ABSTRACT

The present invention discloses a multifunctional flexible handwriting board and its manufacturing method. The multifunctional flexible handwriting board comprises a name plate, a linear plate, a shock absorbing layer and a circuit board. The name plate is made of a flexible material and has an upper surface uses as a mouse pad. The linear plate is made of a flexible material and has a sensing area at the middle. The shock absorbing layer is made of a soft material for protecting the linear plate. The circuit board is electrically coupled to the sensing area of the linear plate for transmitting information. The method of manufacturing the multifunctional flexible handwriting board is to couple the circuit board to an edge of the linear plate and sequentially couple the name plate, the linear plate and the shock absorbing layer.

### BACKGROUND OF THE INVENTION

1. Field of the Invention

The present invention relates to a multifunctional flexible handwriting board and its manufacturing method, and more particularly to a flexible handwriting board structure with both mouse pad and digital input device and its manufacturing method.

2. Description of the Related Art

As science and technology advance, various electronic products are introduced to the market continuously, and different computer peripherals are developed. Since keyboards and mice cannot be used accurately for digital graphics and word processing, therefore digital handwriting boards are developed, such that users can use specific or non-specific writing media to draw pictures or write words in a writing area of the digital handwriting board, and the digital handwriting board converts the created graphics or words into a file and transmits the file to a computer or a storage medium. With this method, users can create graphics or words accurately for digital creations.

However, the conventional digital handwriting board is generally made of a rigid material without flexibility, so that the conventional digital handwriting board has the disadvantages of inconvenience to carry, uneasiness to store, large size and heavy weight.

To overcome the aforementioned problems, the present invention provides a flexible handwriting board that reduces its volume and weight to give light, thin, short and small advantages, so as to improve the portability and convenience of storage.

In addition, a convention digital handwriting board usually provides a digital writing function only, and cannot provide any other function. Therefore, the conventional digital handwriting board is usually stored when not used for digital writing.

Based on this issue, the present invention improves over the conventional digital handwriting board by adding other functions to its application, so that users still can use the digital handwriting board when it is not used for the digital writing function, so as to achieve a multifunctional effect.

### SUMMARY OF THE INVENTION

In view of the aforementioned shortcomings, the inventor of the present invention based on years of experience in the related industry to conduct extensive researches and experiments, and finally developed a multifunctional flexible handwriting board and invented a manufacturing method for the multifunctional flexible handwriting board.

Therefore, it is a primary objective of the present invention to provide a multifunctional flexible handwriting board with a flexible property for reducing its volume and weight to improve its portability and convenience of storage.

Another objective of the present invention is to provide a multifunctional flexible handwriting board with the functions of both digital handwriting board and mouse pad to improve the variation of applications.

A further objective of the present invention is to provide a method for manufacturing a multifunctional flexible handwriting board comprising the steps of: coupling a circuit board to a linear plate, adhering with the linear plate to a name plate and a shock absorbing layer to manufacture the multifunctional flexible handwriting board.

To achieve the foregoing objectives, the present invention provides a multifunctional flexible handwriting board, comprising: a name plate, being made of a flexible material, and having an upper surface used as a mouse pad; a linear plate, being made of a flexible material, and having an upper surface coupled to a lower surface of the name plate, and a sensing area disposed at the center of the linear plate, for sensing an input signal of an input medium; a shock absorbing layer, being made of a soft material, and coupled to a lower surface of the linear plate, for absorbing an external force to prevent the linear plate from being compressed and damaged by the external force; and a circuit board, being coupled to an edge of the linear plate, and electrically coupled to the sensing area of the linear plate, for transmitting the input signal to the circuit board to perform a signal analysis.

The present invention further provides a method for manufacturing a multifunctional flexible handwriting board, comprising the following steps of: (1) providing a linear plate; (2) providing a circuit board, and coupling the circuit board with an edge of the linear plate; (3) providing a name plate, and coupling a lower surface of the name plate to an upper surface of the linear plate; and (4) providing a shock absorbing layer, and coupling the shock absorbing layer to a lower surface of the linear plate.

### BRIEF DESCRIPTION OF THE DRAWINGS

FIG. 1 is a perspective view of a multifunctional flexible handwriting board in accordance with a first preferred embodiment of the present invention;

FIG. 2 is another perspective view of the multifunctional flexible handwriting board in accordance with the first preferred embodiment of the present invention;

FIG. 3 is a cross-sectional view of Section A-A of FIG. 2;

FIG. 4 is an exploded view, showing some of the components of the multifunctional flexible handwriting board in accordance with the first preferred embodiment of the present invention;

FIG. 5 is a schematic circuit block diagram of the multifunctional flexible handwriting board in accordance with the first preferred embodiment of the present invention;

FIG. 6 is a schematic circuit block diagram of the multifunctional flexible handwriting board in accordance with a second preferred embodiment of the present invention;

FIG. 7 is a schematic circuit block diagram of the multifunctional flexible handwriting board in accordance with a third preferred embodiment of the present invention; and

FIG. 8 is a flow chart of a method for manufacturing a multifunctional flexible handwriting board in accordance with the present invention.

### DETAILED DESCRIPTION OF THE PREFERRED EMBODIMENTS

To achieve the foregoing objectives and effects, the inventor of the present invention improves the digital handwriting board made of a flexible material and introduces a material that can be used for making a mouse pad to obtain a multifunctional flexible handwriting board and its manufacturing method in accordance with the present invention. A first preferred embodiment, a second preferred embodiment and a third preferred embodiment of the present invention are used for illustrating the technical characteristics and a manufacturing method of the multifunctional flexible handwriting board.

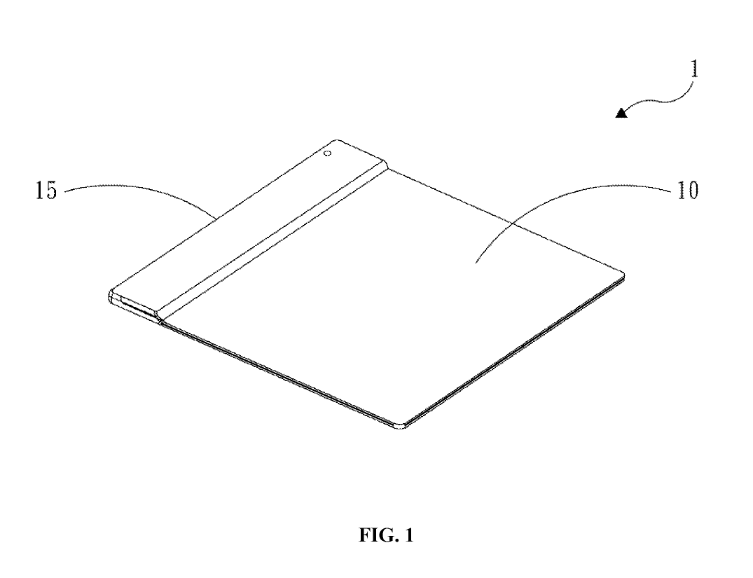

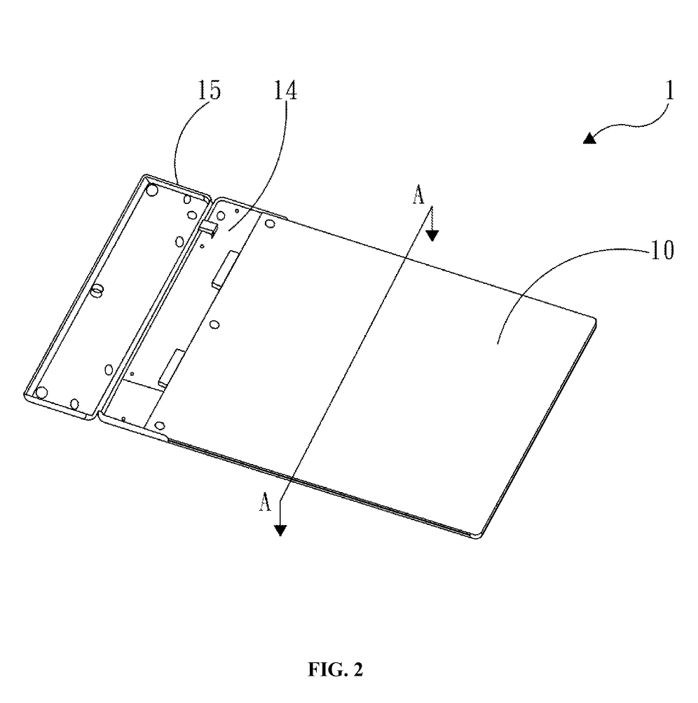

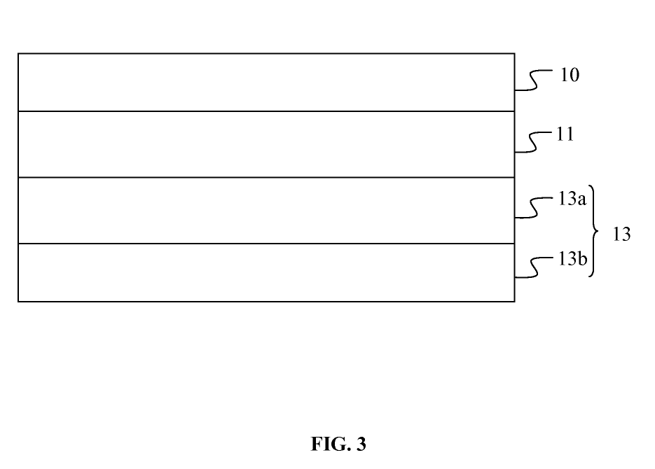

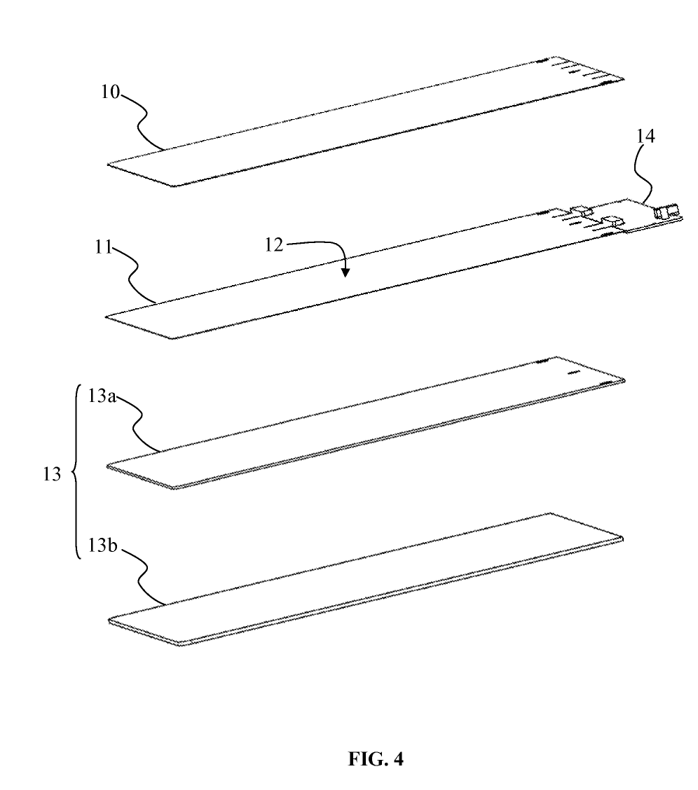

With reference to FIGS. 1 to 4, FIG. 1 shows a perspective view of the first preferred embodiment, FIG. 2 shows another perspective view of the first preferred embodiment, FIG. 3 shows a cross-sectional view of Section A-A of FIG. 2, and FIG. 4 shows an exploded view of the first preferred embodiment in accordance with the present invention.

A multifunctional flexible handwriting board 1 of the first preferred embodiment of the present invention comprises:

a name plate 10, being made of a flexible material, and having an upper surface used as a mouse pad;

a linear plate 11, being made of a flexible material, and having an upper surface coupled to a lower surface of the name plate 10, and a sensing area 12 disposed at the center of the linear plate 11, for sensing an input signal of an input medium;

a shock absorbing layer 13, being made of a soft material, and coupled to a lower surface of the linear plate 11, for absorbing an external force to prevent the linear plate 11 from being compressed and damaged by the external force, wherein the shock absorbing layer 13 further comprises a first soft pad 13a and a second soft pad 13b, and the first soft pad 13a is installed between the linear plate 11 and the second soft pad 13b, and the first soft pad 13a and second soft pad 13b in accordance with the first preferred embodiment of the present invention are made of silicone, and it also can be made of rubber, latex, polytetrafluoroethylene (PTFE), polyvinylchloride (PVC), polypropylene (PP) or any other plastic foam material in other embodiments, and both first soft pad 13a and second soft pad 13b are not limited to be made of the same material;

a circuit board 14, being coupled to an edge of the linear plate 11, and electrically coupled to the sensing area 12 of the linear plate 11, wherein the sensing area 12 is provided for transmitting the input signal to the circuit board 14 to perform a signal analysis; and

a protective cover 15, installed at an external periphery of the circuit board 14, for protecting the circuit board 14 from being damaged.

In the first preferred embodiment, the sensing area 12 of the linear plate 11 is a capacitive sensing area provided for sensing a writable medium such as a finger or an electrostatic pen that carries electrostatic charges. Both X-axis and Y-axis of the capacitive sensing area have a plurality of electrostatic sensing conductive wires for performing X-axis and Y-axis positioning to the writable medium that carries electrostatic charges. The circuit transmission method of the capacitive handwriting board is described in details as follows.

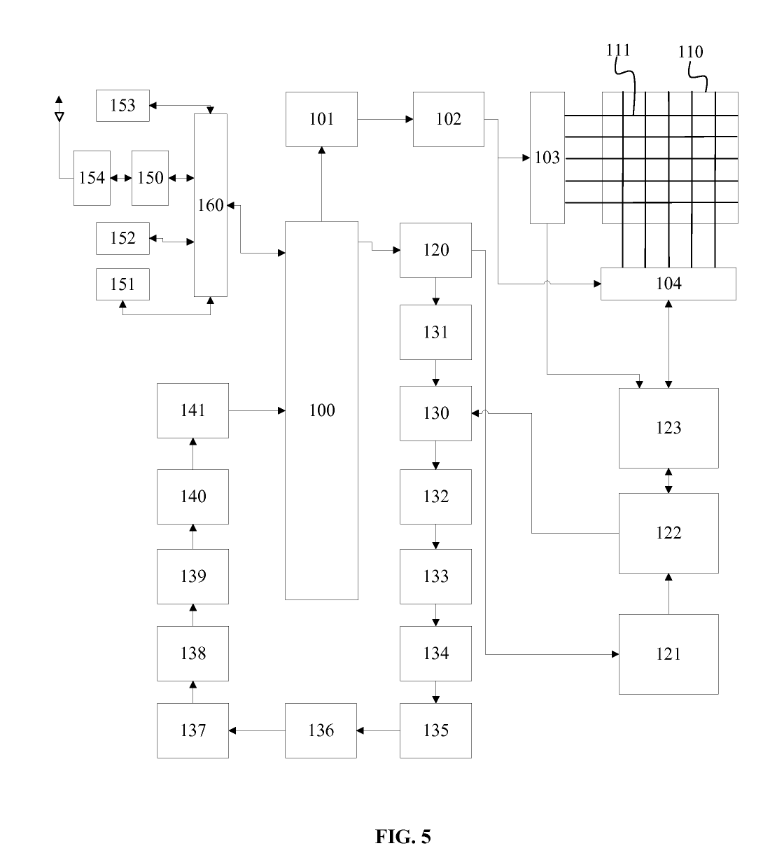

With reference to FIG. 5 for a schematic circuit block diagram of a multifunctional flexible handwriting board in accordance with a first preferred embodiment of the present invention, a central processing unit 100 transmits an address signal to an address buffer circuit 101, and then transmits the address signal to a sensing scan circuit 102, and the sensing scan circuit 102 transmits the signal to an X-axis multiplexer 103 and a Y-axis multiplexer 104 to constitute a complete scan circuit.

If a finger or an electrostatic pen is placed in a capacitive sensing area 110, the sensing scan circuit 102 will sense and detect a sensing voltage at the position where the finger or electrostatic pen is placed. To detect the quantity of electrostatic charges carried by the finger or the electrostatic pen, it is necessary to apply a frequency signal to each electrostatic sensing conductive wire 111. In this method, a clock generator circuit 120 transmits a main frequency signal to a transmitting/receiving circuit 122 through a function timing switching circuit 121, and the transmitting/receiving circuit 122 transmits the main frequency signal to an X/Y axis switching circuit 123, and finally transmits the main frequency signal to each electrostatic sensing conductive wire 111 of the capacitive sensing area 110. If the finger or electrostatic pen is nearby, there will be a significant variation of the main frequency signal of the electrostatic sensing conductive wire 111. In other words, there will be an increased signal voltage at the position where the finger or electrostatic pen is placed, but the voltage level at non-contact areas will remain unchanged.

An electrostatic voltage signal generated by the finger or electrostatic pen is transmitted to a noise blanking circuit 130 sequentially through the X/Y axis switching circuit 123 and the transmitting/receiving circuit 122, and a blanking reference frequency generated by a digital control circuit 131 is provided for eliminating noises included in the electrostatic voltage signal. The signal without noises is transmitted to an amplifier circuit 132 for performing signal amplification, and the amplified signal is transmitted to a comparator 133 for retrieving the most stable signal. After the stable signal is amplified to several times and adjusted by a gain circuit 134, and an integration amplifier circuit 135 and an X/Y coordinate amplifier circuit 136 are provided for amplifying the sensing signal, a band pass filter circuit 137 eliminates a low/high frequency noise of the amplified sensing signal and performs a filtering process. The filtered signal is transmitted to an analog/digital conversion circuit 138 and converted into a pulse signal, and processed by an X/Y coordinate control circuit 139, an X/Y coordinate binary frequency division circuit 140 and a data buffer 141 to obtain complete X/Y coordinate data, and finally the X/Y coordinate data are transmitted to the central processing unit 100 to complete a signal computation process flow.

After the X/Y coordinate data are computed, the central processing unit 100 will transmit the data to an external computing device for performing storage or further computations. In the first preferred embodiment of the present invention, the circuit board 14 further comprises a plurality of transmission interfaces, and the circuit board 14 can be connected to a computing device for performing a data exchange. The transmission interfaces include a universal asynchronous receiver transmitter (UART) 150, a PS/2 interface 151, a universal serial bus (USB) 152 and an infrared data association (IrDA) 153, and an interface select circuit 160 is provided for a setup, and one of the transmission interfaces is selected, wherein the universal asynchronous receiver transmitter (UART) 150 is further used together with a radio frequency (RF) interface 154.

The second and third preferred embodiments are provided for illustrating the present invention below. Since the structure and components of the multifunctional flexible handwriting boards in accordance with the second and third preferred embodiments are the same as the first preferred embodiment, therefore they are not described here again.

In the second preferred embodiment, the sensing area of the linear plate is an alternate sensing area provided for sensing a power signal transmitted by a writable medium, wherein the writable medium is a non-battery power supply wireless sensing pen. Both X-axis and Y-axis of the alternate sensing area include a plurality of power signal sensing conductive wires for performing X-axis and Y-axis positioning to the non-battery power supply wireless sensing pen that transmits the power signal. The circuit transmission method of the power signal sensing type handwriting board is described as follows.

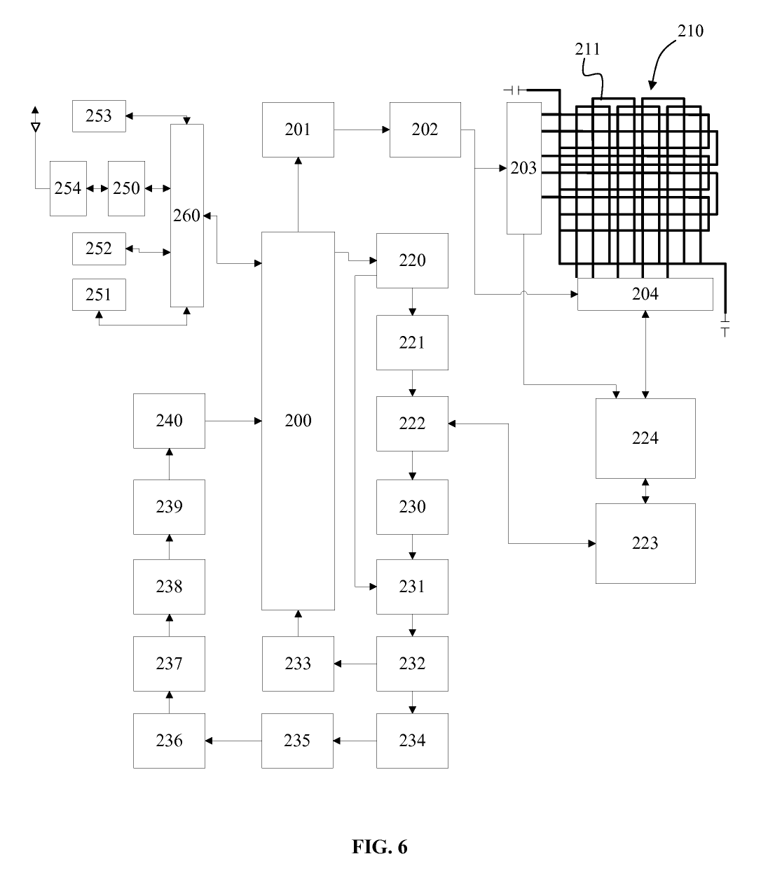

With reference to FIG. 6 for a schematic circuit block diagram of the second preferred embodiment of the present invention, a central processing unit 200 transmits an address signal to an address buffer circuit 201, and then transmits the address signal to a sensing scan circuit 202, and the sensing scan circuit 202 transmits the signal to an X-axis multiplexer 203 and a Y-axis multiplexer 204 to constitute a complete scan circuit.

If a non-battery power supply wireless sensing pen is placed in an alternate sensing area 210, its position will be detected. Since the non-battery power supply wireless sensing pen cannot transmit a power signal actively, therefore it is necessary to supply power by the following method. Firstly, a clock generator circuit 220 sequentially transmits a main frequency signal to a function timing switching circuit 221, a transmitting/receiving circuit 222, a function mode switching circuit 223, an X/Y axis switching circuit 224 and a power signal sensing conductive wire 211 of the alternate sensing area 210. Since an inductive effect is produced by the circuit distribution of the power signal sensing conductive wires 211, and a main frequency signal is transmitted to a sensing coil of the non-battery power supply wireless sensing pen by the mutual induction principle, the sensing coil and a capacitor are provided for storing energy. Now, the non-battery power supply wireless sensing pen has the capability of emitting energy.

The non-battery power supply wireless sensing pen releases energy to the power signal sensing conductive wire 211, and the sensing scan circuit 202 detects a position signal. The position signal is transmitted sequentially to the X/Y axis switching circuit 224, the function mode switching circuit 223, the transmitting/receiving circuit 222 and an amplifier circuit 230 for amplifying the position signal, wherein the amplified signal is processed by a sample and hold circuit 231. The sampled signal is transmitted to a gain circuit 232, a pressure analog/digital conversion circuit 233 and a central processing unit 200, and the central processing unit 200 can amplify or reduce the signal according to the sampled signal. After the gain circuit 232 amplifies or reduces the signal according to an instruction of the central processing unit 200, the signal is transmitted to an integration amplifier circuit 234 and an X/Y coordinate amplifier circuit 235 for performing a signal amplification, and a band pass filter circuit 236 is provided for eliminating a low/high frequency noise and filtering the signal, and the filtered signal is transmitted to an analog/digital conversion circuit 237 and converted into a pulse signal, and then processed by an X/Y coordinate control circuit 238, an X/Y coordinate binary frequency division circuit 239 and a data buffer 240 to obtain complete X/Y coordinate data, and finally the X/Y coordinate data are transmitted to the central processing unit 200 to complete a signal computation process flow.

In the third preferred embodiment, the sensing area of the linear plate is also an alternate sensing area, and its difference from the second preferred embodiment resides on that the writable medium is a battery power wireless sensing pen and a slightly different signal transmission method.

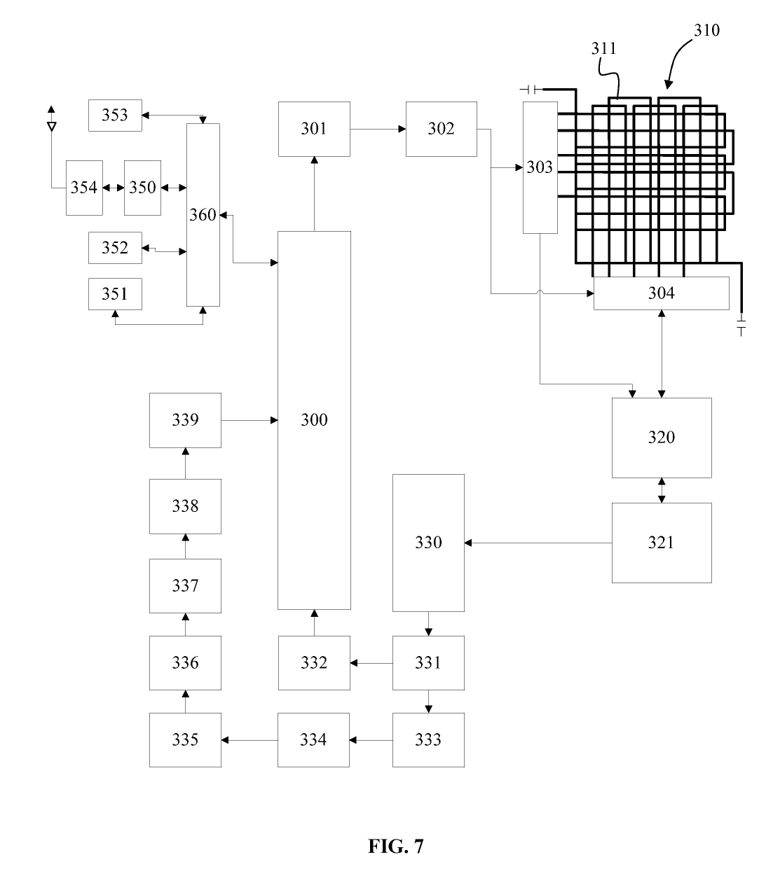

With reference to FIG. 7 for a schematic circuit block diagram of a third preferred embodiment of the present invention, the difference of transmission process flow from the second preferred embodiment signal is described as follows.

Since the battery power wireless sensing pen can emit energy actively, therefore the power signal can be transmitted directly to an X/Y axis switching circuit 320, a function mode switching circuit 321 and an amplifier circuit 330 for amplifying the signal, and the amplified signal is transmitted to a gain circuit 331, a pressure analog/digital conversion circuit 332 and a central processing unit 300, and the central processing unit 300 is provided for amplifying or reducing the signal as needed. After the gain circuit 331 amplifies or reduces the signal according to an instruction of the central processing unit 300, the same process of the second preferred embodiment follows, and an integration amplifier circuit 333, an X/Y coordinate amplifier circuit 334, a band pass filter circuit 335, an analog/digital conversion circuit 336, an X/Y coordinate control circuit 337, an X/Y coordinate binary frequency division circuit 338 and a data buffer 339 are provided for obtaining complete X/Y coordinate data, and finally the X/Y coordinate data are transmitted to the central processing unit 300 to complete a signal computation process flow.

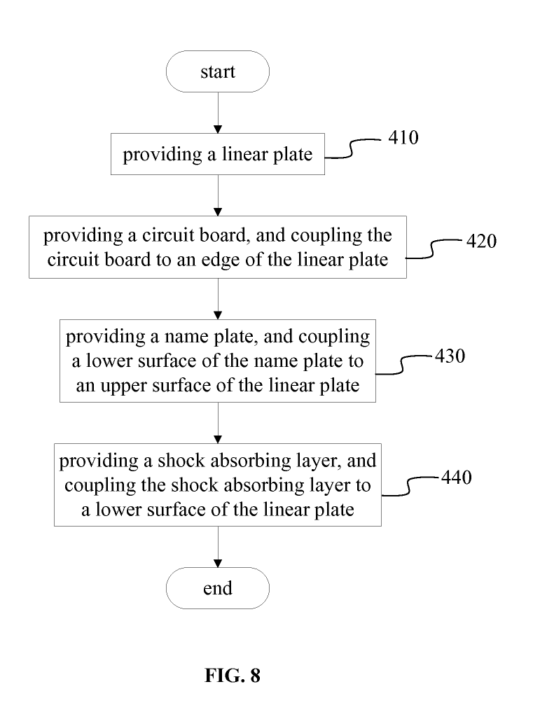

Finally, a method for manufacturing a multifunctional flexible handwriting board in accordance with the present invention is described in details as follows. With reference to FIG. 8 for a flow chart of a method for manufacturing a multifunctional flexible handwriting board in accordance with the present invention, the method comprises the steps of: (Step 410) providing a linear plate; (Step 420) providing a circuit board, and coupling the circuit board to an edge of the linear plate; (Step 430) providing a name plate, and coupling a lower surface of the name plate to an upper surface of the linear plate, wherein the coupling method adopts a back adhesive; and (Step 440) providing a shock absorbing layer, and coupling the shock absorbing layer to a lower surface of the linear plate, wherein the shock absorbing layer further comprises a first soft pad and a second soft pad, and the first soft pad is installed between the linear plate and the second soft pad, and the back adhesive is applied between the linear plate and the first soft pad, and between the first soft pad and the second soft pad for performing an adhesion. By the aforementioned method, the multifunctional flexible handwriting board is manufactured.

In summation to the overall structure and technical characteristics of the present invention, the present invention has the following advantages:

The multifunctional flexible handwriting board of the present invention is made of a flexible material, so that the board can be bent or rolled to provide improved portability and convenience for storage.

The multifunctional flexible handwriting board of the present invention comes with reduced volume and weight to improve portability and convenience for storage.

The multifunctional flexible handwriting board of the present invention integrates the function of a mouse pad, so that users can use the board as a mouse pad, and the handwriting board provides a multifunctional advantage.

The linear plate of the present invention can include a capacitive sensing area or an alternate sensing area as required, or integrate both sensing areas to improve the variability of the digital handwriting.

What is claimed is:

1. A multifunctional flexible handwriting board, comprising:
a name plate, being made of a flexible material, and having an upper surface usable as a mouse pad;
a linear plate, being made of a flexible material, and having an upper surface coupled to a lower surface of the name plate, a sensing area being formed at the center of the linear plate for sensing an input signal of an input medium;
a shock absorbing layer, being coupled to a lower surface of the linear plate, and made of a soft material, and provided for absorbing an external force to prevent the linear plate from being compressed and damaged by the external force; and
a circuit board, being coupled to an edge of the linear plate and electrically coupled to the sensing area of the linear plate, such that the sensing area can transmit the input signal to the circuit board for performing a signal analysis.

2. The multifunctional flexible handwriting board of claim 1, wherein the circuit board includes at least one transmission interface, such that the circuit board can be coupled to a computing device for performing a data exchange.

3. The multifunctional flexible handwriting board of claim 2, wherein the transmission interface is selected from the group consisting of: a universal asynchronous receiver transmitter (UART), a PS/2 interface, a universal serial bus (USB) and an infrared data association (IrDA), and set by an interface select circuit to select one from the group as a transmission interface.

4. The multifunctional flexible handwriting board of claim 1, wherein the shock absorbing layer comprises a first soft pad and a second soft pad, the first soft pad being installed between the linear plate and the second soft pad.

5. The multifunctional flexible handwriting board of claim 4, wherein the first soft pad is made of a material selected from the group consisting of: rubber, silicone, latex, polytetrafluoroethylene (PTFE), polyvinylchloride (PVC), polypropylene (PP) and plastic foam.

6. The multifunctional flexible handwriting board of claim 4, wherein the second soft pad is made of a material selected from the group consisting of: rubber, silicone, latex, polytetrafluoroethylene (PTFE), polyvinylchloride (PVC), polypropylene (PP) and plastic foam.

7. The multifunctional flexible handwriting board of claim 1, further comprising a protective cover installed at an external periphery of the circuit board for protecting the circuit board from being damaged.

8. The multifunctional flexible handwriting board of claim 1, wherein the sensing area of the linear plate is a capacitive sensing area provided for sensing a writable medium that carries electrostatic charges.

9. The multifunctional flexible handwriting board of claim 8, further comprising a plurality of electrostatic sensing conductive wires installed at both the X-axis and Y-axis of the capacitive sensing area respectively, for performing the X-axis and Y-axis positioning to the writable medium that carries electrostatic charges.

10. The multifunctional flexible handwriting board of claim 1, wherein the sensing area of the linear plate is an alternate sensing area for sensing a power signal transmitted by a writable medium.

11. The multifunctional flexible handwriting board of claim 10, wherein the writable medium is selected from the group consisting of: a non-battery power supply wireless sensing pen and a battery powered wireless sensing pen.

12. The multifunctional flexible handwriting board of claim 10, further comprising a plurality of power signal sensing conductive wires installed at both the X-axis and Y-axis of the alternate sensing area respectively for performing the X-axis and Y-axis positioning to the writable medium that transmits a power signal.

13. A method for manufacturing a multifunctional flexible handwriting board, comprising the steps of:
(1) providing a linear plate;
(2) providing a circuit board, and coupling the circuit board to an edge of the linear plate;
(3) providing a name plate, and coupling a lower surface of the name plate to an upper surface of the linear plate; and
(4) providing a shock absorbing layer, and coupling the shock absorbing layer to a lower surface of the linear plate.

14. The manufacturing method for the multifunctional flexible handwriting board as recited in claim 13, further comprising a back adhesive for performing an adhesion between the name plate and the linear plate.

15. The manufacturing method for the multifunctional flexible handwriting board as recited in claim 13, further comprising a back adhesive for performing an adhesion between the linear plate and the shock absorbing layer.

16. The manufacturing method for the multifunctional flexible handwriting board as recited in claim 13, wherein the shock absorbing layer comprises a first soft pad and a second soft pad, and the first soft pad being installed between the linear plate and the second soft pad.

17. The manufacturing method for the multifunctional flexible handwriting board as recited in claim 16, further comprising a back adhesive for performing an adhesion between the first soft pad and the second soft pad.
